(19) United States
(12) Patent Application Publication
(10) Pub. No.: US 2007/0233505 A1
(43) Pub. Date: Oct. 4, 2007

(54) Community friendly retail land development

(76) Inventor: Gary Erb, Crystal Lake, IL (US)

Correspondence Address: MILLER, MATTHIAS & HULL, ONE NORTH FRANKLIN STREET, SUITE 2350, CHICAGO, IL, 60606, US

(21) Appl. No.: 11/396,874

(22) Filed: Apr. 3, 2006

(51) Int. Cl. G06Q 10/00; G06Q 30/00

(52) U.S. Cl. 705/1

(57) ABSTRACT

A retail land development site is positioned adjacent an existing road and includes an access road intersecting the existing road, a full-time retail area, and a permanent store structure disposed within the full-time retail area and housing an anchor retailer. A community area is provided within the site, and a permanent display structure is disposed within the community area, the display structure including at least one display area for use during a part-time community event. A common parking area is disposed between the permanent display structure and the permanent store structure, and a thoroughfare is disposed within the community area and sized for vehicular traffic. The thoroughfare connects the access road to the common parking area.

### FIELD OF THE DISCLOSURE

The present disclosure is generally related to land development, and more particularly to the development of land sites intended for retail use.

### BACKGROUND OF THE DISCLOSURE

Land sites have been developed for retail use in a variety of manners. Strip malls are often built on relatively small plots of land, and typically are constructed as a single structure that is divided into separate sections for housing different retailers. Larger plots of land may be developed with multiple buildings, which may be large, small, or a combination thereof. One type of large plot development is an outdoor mall, which commonly consists of multiple large buildings each housing one or more retailers.

Other larger developments may consist of a combination of one or more larger buildings spaced away from an existing road and one or more smaller out-buildings positioned near the road. The larger buildings may be occupied by a national or regional anchor retailer, which have recently proliferated and often drive the development of a land site. Such anchor retailers have multiple retail sites or stores in a given region or multiple regions. Each retail site of a particular retail anchor has substantially the same appearance, and is commonly housed in a relatively large building on the order of 30,000 square feet or more. In common parlance, these large anchor retailers are known as “big box” stores.

Proposed land site developments that include big box retailers pose a difficult issue to local governments, which are commonly charged with reviewing and approving land site development plans. On the one hand, such big box stores are exceedingly popular with consumers, and offer the community a greater choice of goods to purchase, often at a reasonable price. Local governments will typically balance these benefits with the possible challenges such a development poses to the community. Specifically, land development sites that include a big box retailer may result in greater or more concentrated vehicle traffic adjacent the development, erosion or loss of a community's unique aesthetic or charm, and a possible drop in business generated by local retailers. As a result, local governments are increasingly denying or delaying proposed developments, or are otherwise requiring substantial changes to the plans that may make them economically less attractive or infeasible.

Accordingly, it is desirable to provide a retail development site that minimizes the potential drawbacks associated with large anchor retailers while still providing the convenience and increased consumer choice offered by such developments.

### SUMMARY OF THE DISCLOSURE

In view of the foregoing, a retail land development site is disclosed that includes a full-time retail area, a permanent store structure disposed within the full-time retail area and housing a retail operator, and a community area. A display structure is disposed within the community area and includes at least one display area for use during a part-time community event.

According to additional aspects, a retail land development site is disclosed that includes a full-time retail area, a permanent store structure disposed within the full-time retail area and housing an anchor retailer, and a community area. A permanent display structure is disposed within the community area and includes at least one display area for use during a part-time community event.

According to further aspects, a retail land development site is positioned adjacent an existing road and includes an access road intersecting the existing road, a full-time retail area, and a permanent store structure disposed within the full-time retail area and housing an anchor retailer. A community area is provided within the site, and a permanent display structure is disposed within the community area, the display structure including at least one display area for use during a part-time community event. A common parking area is disposed between the permanent display structure and the permanent store structure, and a thoroughfare is disposed within the community area and sized for vehicular traffic. The thoroughfare connects the access road to the common parking area.

### BRIEF DESCRIPTION OF THE DRAWINGS

For a more complete understanding of the disclosed subject matter, reference should be made to the embodiments illustrated in greater detail on the accompanying drawings, wherein:

FIG. 1 is a schematic diagram of a retail land development site according to a first embodiment of this disclosure;

FIG. 1A is a schematic diagram of a retail land development site similar to FIG. 1, but including a second full-time retail area;

FIG. 2 is a schematic diagram of a retail land development site according to an additional embodiment of the disclosure;

FIG. 3 is an enlarged schematic diagram of a portion of a community area incorporated into the retail land development site shown in FIG. 2;

FIG. 4 is a side elevation view, in cross-section, of an open air display structure for use in a community area of a retail land development site;

FIG. 5 is a side elevation view, in cross-section, of a display structure that may be converted from an open air configuration to a closed configuration;

FIG. 6 is a schematic diagram of a retail land development site according to a further embodiment of the disclosure;

FIG. 7 is a schematic diagram of a retail land development site according to yet another embodiment of the disclosure;

FIG. 8 is a schematic diagram of a retail land development site according to a still further embodiment of the disclosure; and

FIG. 9 is a schematic diagram of a retail land development site according to an additional embodiment of the disclosure.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive, may have been omitted. It should be understood, of course, that this disclosure is not limited to the particular embodiments illustrated herein.

### DETAILED DESCRIPTION

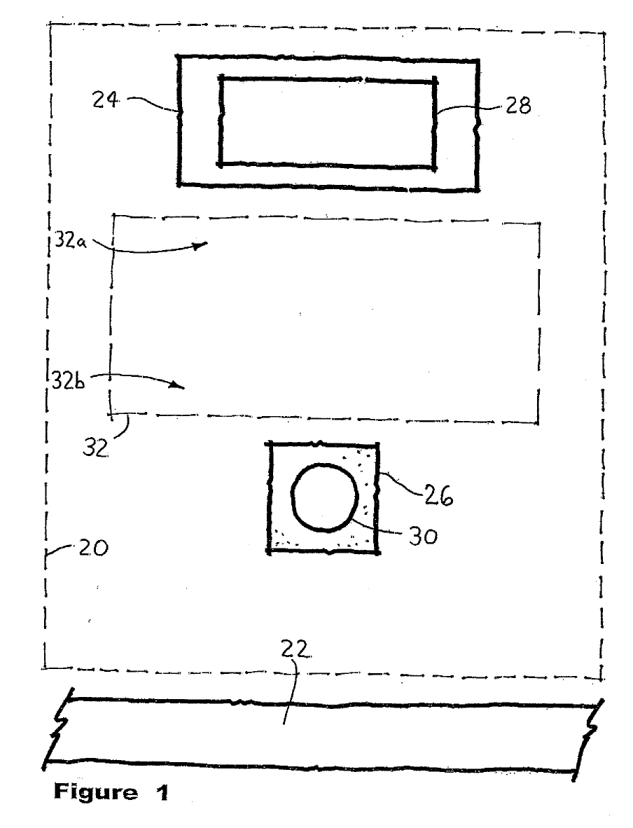

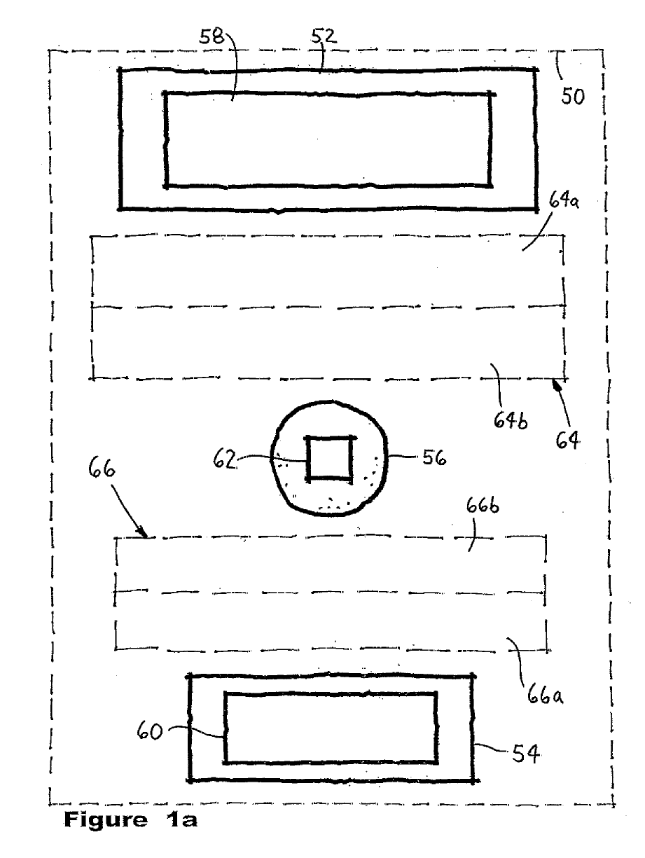

A first embodiment of a retail land development site 20 according to the present disclosure is illustrated in FIG. 1. The land development site 20 is located adjacent to an existing road 22 and includes a full-time retail area 24 and a part-time community area 26. Disposed within the full-time retail area 24 is a permanent store structure 28 adapted to house one or more full-time retailers. A community structure 30 is disposed within the community area 26. The community structure 30 may be a temporary or permanent construction, and is adapted to accommodate part-time or temporary community events. In the illustrated embodiment, a common parking area 32 is disposed between the full-time retail area 24 and the community area 26.

The permanent store structure 28 located within the full-time retail area 24 is sized to accommodate one or more full-time retailers. The full-time retailers continuously occupy the permanent store structure 28, although the retailer may be open for business only during normal business hours. Normal business hours are those hours during which the store is regularly scheduled to be open, and may encompass a variety of particular times. For example, some retailers may be open only during certain hours of the day, such as 9:00 a.m. to 9:00 p.m. during week days and 10:00 a.m. to 6:00 p.m. during weekends. Other retailers may be open for business twenty-four hours a day, 365 days a year. The specific hours of operation identified herein as normal business hours are merely exemplary, as various other combinations of hours and/or days may be used without departing from the scope of the claims presented herein.

The one or more retailers housed in the permanent store structure 28 may be engaged in any type of commercial activity. For example, the retailer may be operating a store for selling goods, such as hardware or household items, a store for selling services, a restaurant, or other type of business. Again, these are provided as examples only and are not intended to limit the invention disclosed herein.

In certain embodiments, the retailer may be a regional or national anchor retailer. Regional and national anchor retailers are users or tenants which require a relatively large store size, such as 30,0000 square feet or larger. A regional anchor retailer has multiple same- or similarly-branded stores in a given region, such as a county, group of neighboring counties, or states. A national anchor retailer has multiple same- or similarly-branded stores in numerous regions of a given country. Both regional and national anchor retailers advertise for their numerous store locations within the applicable region or regions. Such anchor retailers are further recognized for continuity among their various locations, such as by providing similar store layouts, products, or pricing. Some anchor retailers are commonly called “big box” stores, which are known for having relatively large store facilities that conduct high volume business.

In contrast with the store structure 28 disposed in the full-time retail area 24, the display structure 30 of the community area 26 accommodates part-time or temporary community events. Such events may be conducted at times other than the normal business hours of the full-time retailers or may overlap with full-time retailer operations on certain days or portions of days. For example, the display area 30 may be used to conduct an event that occurs only on weekends between the hours of 6:00 a.m. and 12:00 p.m. Exemplary part-time community events include, but are not limited to, commercial events, such as a farmers market, a community market, an art or craft fair, and special or limited retail events, as well as non-commercial events, such as art displays, musical or theatrical performances, and public hearings. The particular events listed above are provided as examples only and do not limit the scope of the subject matter claimed herein.

As noted above, the display structure 30 may be of permanent or temporary construction, using any known materials and designs for creating a structure suitable for a community event.

The common parking area 32 is positioned between the community area 26 and the full-time retail area 24 to providing parking convenient to patrons of both the display structure 30 and the permanent store 28. Accordingly, the common parking area 32 is suitably sized to accommodate a plurality of vehicles.

In addition, the full-time retail area 24 and the community area 26 may be located with respect to the parking area 32 to limit the amount of additional parking space required for the community area 26. Parking requirements are significant not only in terms of the amount of space needed for parking, but also with respect to the additional space needed for detention because of the additional parking, as well as drainage or other considerations that might be needed to accommodate the additional parking. Consequently, additional parking space may reduce the potential revenue that may be generated by a development and may increase the costs of developing the site, and therefore developers may be reluctant to incorporate an area having limited revenue-generating potential into a land site development plan

The land development site 20 of FIG. 1, however, minimizes the impact of the community area 26 on parking by locating the community area 26 adjacent a portion of the parking area 32 that is remote from the full-time retail area 24. The permanent store 28 requires a parking area that is sufficiently large to accommodate a volume of vehicles estimated for peak periods of operation, when the permanent store 28 is busiest. Naturally, patrons tend to park their vehicles in spots located closest to the store 28, often leaving the remote areas of a parking lot unused. As illustrated in FIG. 1, the common parking area 32 has a first portion 32a positioned proximal to the permanent store structure 28 and a second portion 32b positioned distal from the permanent store structure 28. The community area 26 may be positioned adjacent the second portion 32b so that patrons of the community area 26 will be more likely to use parking spaces that are relatively remotely located from the permanent store 28. As a result, the community area 26 will have little impact on parking availability adjacent the permanent store 28. Furthermore, to the extent the part-time community events taking place in the community area 26 are limited to off-peak hours, the overall impact of the community area 26 on parking space needs is minimized, thereby making the inclusion of a community area 26 in a retail development more feasible.

An additional embodiment of a retail land development site 50 is illustrated in FIG. 1A. The land development site 50 includes a first full-time retail area 52, a second full-time retail area 54, and a community area 56. A permanent store 58 is disposed within the first full-time retail area 52 that may be operated by a first retailer, such as an anchor retailer. A second store 60 is disposed within the second full-time retail area 54 that may be operated by a second retailer. A display structure 62 is disposed within the community area 56 for hosting part-time community events. A first common parking area 64 is located between the community area 56 and the first full-time retail area 52, while a second common parking area 66 is located between the community area 56 and the second full-time retail area 54. The first common parking area 64 includes a proximal portion 64a located nearer the first full-time retail area 52 and a remote portion 64b located farther from the first full-time retail area 52. Similarly, the second common parking area 66 includes a proximal portion 66a located nearer the second full-time retail area 54 and a remote portion 66b located farther from the second full-time retail area 54. The community area 56 is positioned adjacent the remote portions 64b, 66b of the first and second common parking areas 64, 66, thereby to minimize or eliminate parking space required for the community area 56.

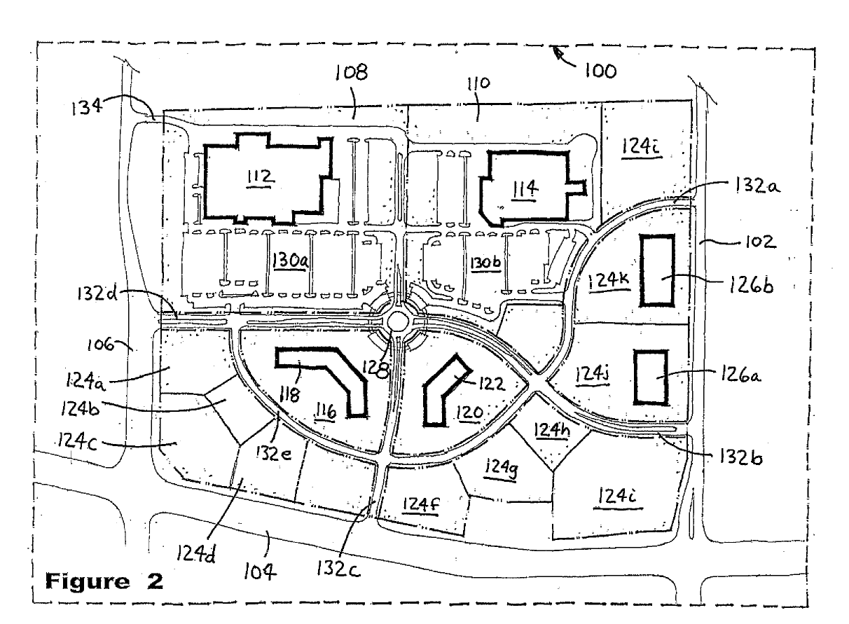

An alternative retail land development site 100 is illustrated in FIG. 2. The development site 100 is positioned adjacent a first existing road 102, a second existing road 104, and a third existing road 106. The land development site 100 includes first and second full-time retail areas 108, 110 in which are disposed first and second large store structures 112, 114. Additional full-time retail areas 116, 118 are spaced from the large store structures 112, 114 and include retail structures 120, 122, respectively. The retail land development site 100 may further be subdivided to include additional full-time retail areas 124a-l located around a periphery of the site 100. Each of these additional areas 124a-l may include a permanent retail structure, such as out-buildings 126a and 126b disposed in areas 124j and 124k, respectively. A community area 128 is generally centrally located within the land development site 100. Common parking areas 130a, 130b are positioned between the community area 128 and the large store structures 112, 114. First and second access roads 132a, 132b intersect the first existing road 102, access road 132c intersects the second existing road 104, and access road 132d intersects the third existing road 106. The access roads 132a-d may either intersect directly or may be linked by an intermediate access road 132e. While the access roads 132a-e provide common paths to and from multiple full-time retail areas 108, 110, and 124a-l, the land development site 100 may also include a dedicated secondary access road 134 serving a single area, such as full-time retail area 108.

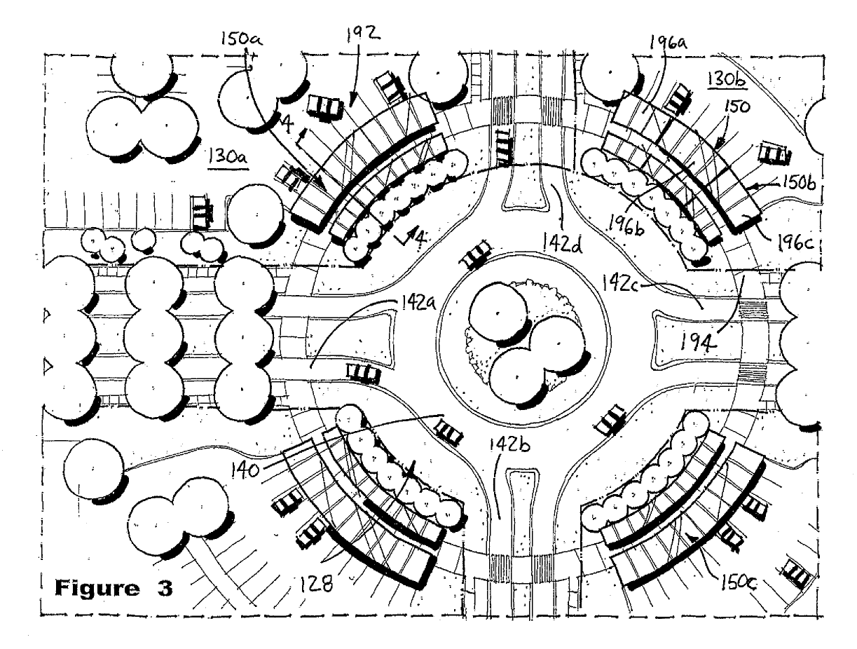

The community area 128 is shown in greater detail in FIG. 3. In the illustrated embodiment, the community area 128 includes a thoroughfare, such as roundabout 140, connecting one or more access roads 132a-d. In the illustrated embodiment, the roundabout 140 includes spurs 142a-d connected to respective access roads. Accordingly, vehicular traffic passing through the land development site 100 is generally directed through the community area 128.

The community area 128 further includes a display structure 150 for accommodating temporary events. In the illustrated embodiment, the display area 150 includes display area sections 150a, 150b and 150c. It will be noted, however, that the display structure 150 may be a single, unitary structure, or may be comprised of less than or more than the three sections 150a-c illustrated in FIG. 3. It is further noted that display structure sections 150a and 150b are located on opposite sides of spur 142d and that, similarly, display structure sections 150b and 150c are located on the opposite sides of spur 142c.

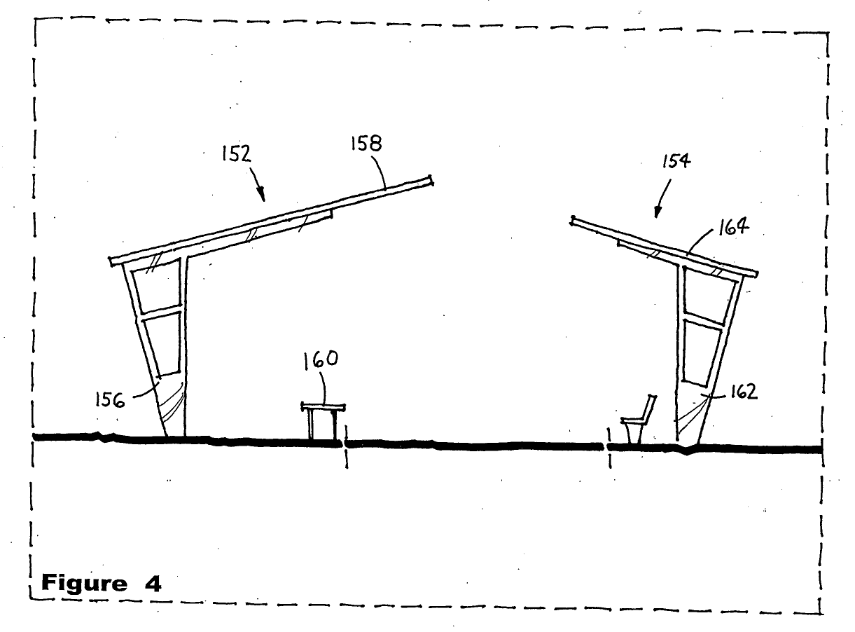

Each display structure section 150a-c may include an exhibitor area 152 and a pedestrian area 154, as best shown in FIG. 4. In the illustrated embodiment, the exhibitor area 152 is formed as a free-standing, cantilever-type structure that includes a support 156 and a roof 158, which may be provided as a translucent canopy. A platform, such as table 160, is positioned beneath the roof 158 and is sized for use during a temporary event. For example, the table 160 may be used as stage for artistic performances, or may be used to support goods offered for sale. The pedestrian portion 154 is also shown as a free-standing, cantilever-type structure that includes a support 162 and a roof 164. The exhibitor and pedestrian portions, 152, 154 are positioned with respect to each other such that a gap is provided between the respective roofs 158, 164, thereby to provide an open-air structure. A pedestrian walkway 194 passes through each display structure section 150a-c to provide pedestrian access between the display structure sections and between the community area 128 and surrounding areas, such as the parking areas 130a, 130b.

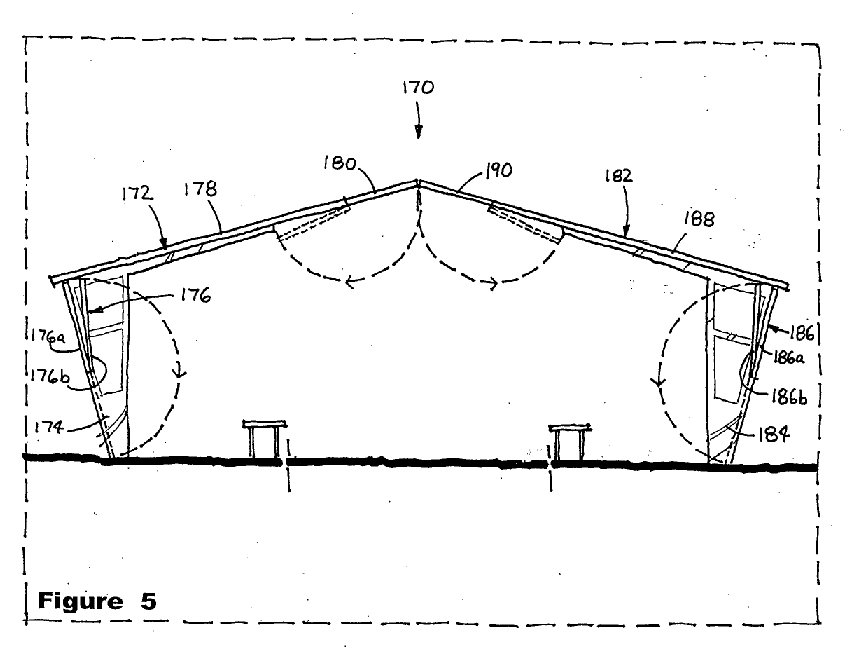

An alternative display structure 170 is illustrated in FIG. 5, wherein the display structure 170 may be converted from an open-air structure to a closed structure. As shown in FIG. 5, a first portion 172 includes a support frame 174, a sidewall 176, and a roof 178. The sidewall 176 includes a stationary portion 176a and moveable portion 176b hingedly connected to the stationary section. Accordingly, the sidewall 176 is moveable between a closed position, in which the moveable section 176b extends between the stationary section 176a and the ground, and an open position, in which the moveable section 176b substantially overlies the stationary section 176a. Similarly, the roof 178 includes a moveable extension 180 that may also be moved between open and closed positions. A second display structure section 182 includes a support frame 184, a sidewall 186, and a roof 188. The sidewall 186 includes a stationary section 186a and a moveable section 186b, which may be pivoted between opened and closed positions. The roof 188 includes an extension 190 which may also be pivoted between opened and closed positions. Accordingly, this alternative display structure 170 may be converted between closed and open-air configurations by moving the sidewalls 176b, 186b and/or roof extensions 180, 190 to the desired positions.

An exhibitor parking and loading area may be provided adjacent the display structure 150. As best shown in FIG. 3, the exhibitor parking and loading area 192 is positioned adjacent the exhibitor section 152 of each display structure section 150a-c.

The display structure 150 may include a plurality of individual bays, such as bays 196a-c, for accommodating multiple different exhibitors. Each bay 196a-c may be operated by a different exhibitor, and therefore the display structure 150 may simultaneously house a plurality of different exhibits. When housing a farmers market, for example, bay 196a may be operated by a fruit vendor, bay 196b may be operated by a vegetable vendor, and bay 196c may be operated by a craft vendor. Additionally or alternatively, one or more of the bays may be operated by one of the retailers having a store located in a full-time retail area.

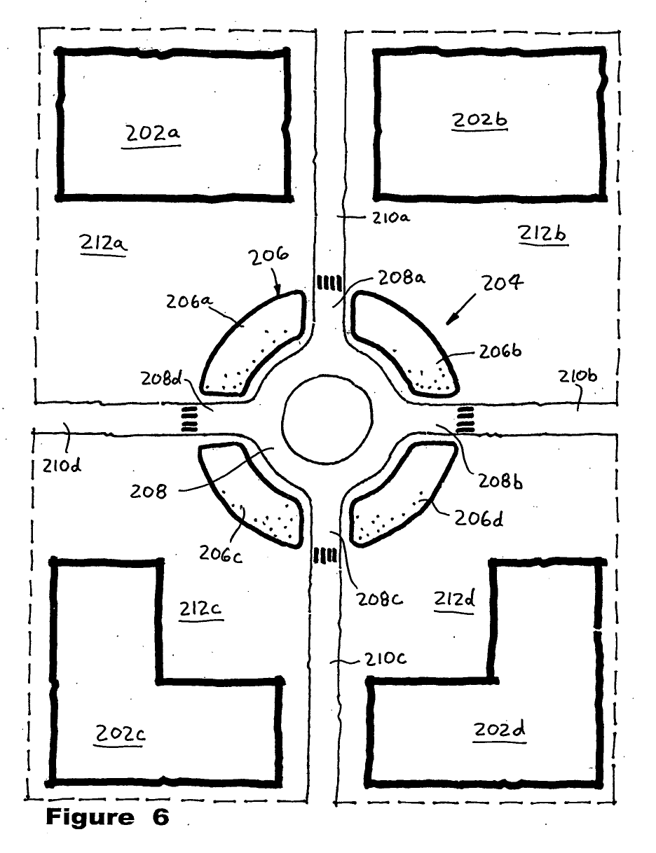

FIGS. 6-9 illustrate alternative configurations for the retail land development site. In FIG. 6, a retail land development site 200 is shown including four full-time retail areas 202a-d located around a perimeter of the site 200 and a community area 204 generally centrally located within the site. A display structure 206 is located within the community area 204 and includes four sections, 206a-d. A roundabout 208 is also disposed within the community area and includes spurs 208a-d which connect with respective access roads to 10a-d. Common parking areas 212a-d are disposed between the display structure 206 and each full-time retail area 202a-d.

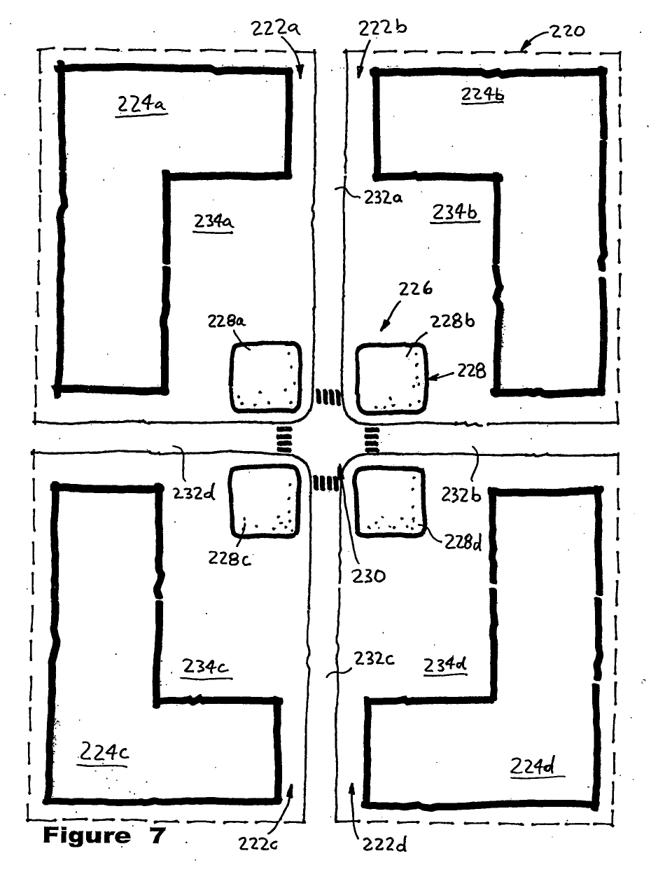

FIG. 7 illustrates an alternative embodiment in which the community area incorporates a four-way stop. A retail land development site 220 includes four full-time retail areas 222a-d. A permanent store structure 224a-d is disposed within each full-time retail area 222a-d. In the illustrated embodiment, each of the permanent store structures 224a-d has a general L-shape, and is located near a periphery of the site 220. While this embodiment includes buildings with an L-shape, it will be appreciated that the particular shape and configuration of the buildings are not significant to the present invention, and that building having shapes and configurations other than those specifically disclosed herein may be used without departing from the scope of this disclosure. A community area 226 is generally centrally located within the site 220 and includes a-display structure 228 including four sections, 228a-d. The community area 226 includes a thoroughfare sized for vehicular traffic in the form of a four-way intersection 230. The intersection 230 is preferably controlled, such as by stop signs or traffic lights. The intersection 230 is further connected to access roads 232a-d. As with the previous embodiments, the thoroughfare allows vehicular traffic between adjacent display structure sections 228a-d. Parking areas 234a-d are located between the community area 226 and each full-time store structure 224a-d.

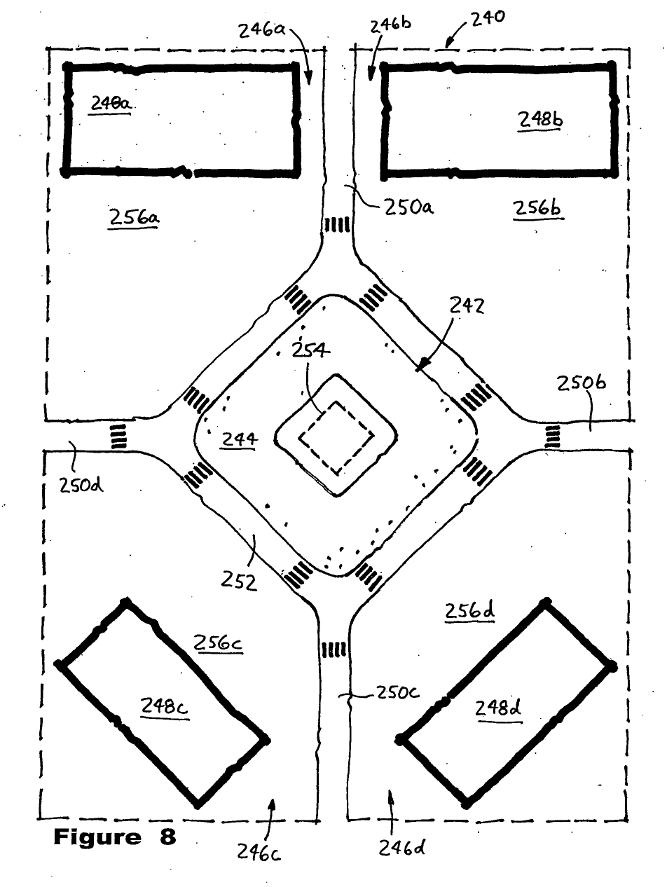

A further embodiment of a retail land development site 240 having a generally diamond-shaped community area 242 having an immediate parking area 244 is illustrated in FIG. 8. The land development site 240 includes full-time retail areas 246a-d each having a permanent store structure 248a-d, respectively. Four access roads 250a-d are connected by a loop 252 extending around a perimeter of the community area 242. The community area 242 includes a display structure 254 disposed within the immediate parking area 244. Additional parking areas 256a-d are located between the community area 242 and each permanent 248a-d, respectively.

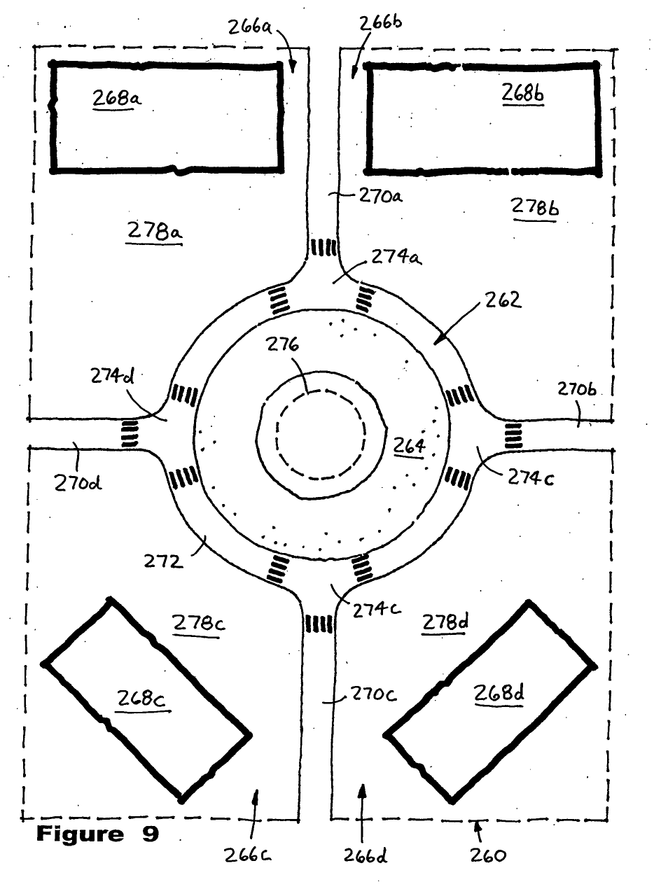

Yet another embodiment of a retail land development site 260 having a generally circular-shaped community area 262 that includes an immediate parking area 264 is illustrated in FIG. 9. The retail land development site 260 includes full-time retail store areas 266a-d, each of which includes a permanent store structure 268a-d. Four access roads 270a-d are provided and connected by a loop 272 which extends around a perimeter of the community area 262. Each intersection 274a-d defined between the loop 272 and the access roads 270a-d may be either controlled such as by stop signs or traffic signals, or uncontrolled. The community area 262 further includes a substantially circular-shaped display structure 276 disposed within the immediate parking area 264. Additional parking areas 278a-d are located between the community area 262 and each permanent store structure 268a-d.

As will be seen from the foregoing exemplary embodiments, the full-time retail area and the community area may have various types of shapes and layouts. In addition, the thoroughfare extending through the community area may also have various configurations.

The retail land development sites disclosed herein balance the interests of the retailer, which desires to construct a new store for accommodating a potentially high volume of customers, with that of the community, which may be concerned about the impact of the development on the aesthetics or the traffic flow through the area. The inclusion of a community area, which generates little or no profit, provides the community with facilities for hosting temporary events. In addition, the community area may host events which attract additional visitors to the site, thereby increasing the number of potential customers drawn to the development, to the benefit of the full-time retailers.

While the foregoing was written with reference to specific examples and embodiments, it is to be understood that the scope of the disclosure is not limited thereby. Instead, the detailed description is provided to satisfy best mode and enablement requirements while providing support for any and all claim which may issue herefrom.

What is claimed:

1. A retail land development site, comprising:
a full-time retail area;
a permanent store structure disposed within the full-time retail area and housing a retail operator;
a community area; and
a display structure disposed within the community area, the display structure including at least one display area for use during a part-time community event.

2. The land development site of claim 1, in which the display structure includes a plurality of display areas.

3. The land development site of claim 2, in which the part-time community event comprises a farmers market, and in which the display areas comprise vendor bays.

4. The land development site of claim 3, in which at least one of the vendor bays is associated with the retail operator.

5. The land development site of claim 3, in which the community area further includes a vendor parking area.

6. The land development site of claim 1, in which the community area is generally centrally located within the land development site, and in which the full-time retail area is located nearer a periphery of the land development site.

7. The land development site of claim 1, in which a common parking area is disposed between the community area and the permanent store structure.

8. The land development site of claim 7, in which the common parking area includes a first portion located proximal the full-time retail area and a second portion located remote from the full-time retail area, and in which the community area is positioned adjacent the common parking area second portion.

9. The land development site of claim 8, in which the display structure has open-air and closed configurations.

10. The land development site of claim 1, in which the community area further includes a thoroughfare sized for vehicular traffic.

11. The land development site of claim 10, in which the display structure includes a plurality of free-standing sections, and in which the thoroughfare passes between at least one pair of adjacent free-standing sections of the display structure.

12. The land development site of claim 10, in which the land development site includes at least one access road, and in which the thoroughfare includes a roundabout and a spur connecting the roundabout to the at least one access road.

13. The land development site of claim 12, in which the land development site further includes a second access road, and the thoroughfare includes a second spur connecting the roundabout to the second access road.

14. The land development site of claim 1, in which the display structure includes a free-standing exhibitor area and a free-standing pedestrian area, and in which a pedestrian walkway passes between the exhibitor area and the pedestrian area.

15. A retail land development site, comprising:
a full-time retail area;
a permanent store structure disposed within the full-time retail area and housing an anchor retailer;
a community area; and
a permanent display structure disposed within the community area, the display structure including at least one display area for use during a part-time community event.

16. The retail land development site of claim 15, in which the permanent display structure comprises a plurality of vendor bays.

17. The retail land development site of claim 16, in which at least one of the vendor bays is associated with the anchor retailer.

18. The retail land development site of claim 15, in which the community area further includes a thoroughfare sized for vehicular traffic.

19. The land development site of claim 18, in which the display structure includes a plurality of free-standing sections, and in which the thoroughfare passes between at least one pair of adjacent free-standing sections of the display structure.

20. The land development site of claim 15, in which a common parking area is disposed between the permanent display structure and the permanent store structure.

21. The land development site of claim 20, in which the common parking area includes a first portion located proximal the full-time retail area and a second portion located remote from the full-time retail area, and in which the community area is positioned adjacent the common parking area second portion.

22. A retail land development site positioned adjacent an existing road, the retail land development site comprising:
an access road intersecting the existing road;
a full-time retail area;
a permanent store structure disposed within the full-time retail area and housing an anchor retailer;
a community area;
a permanent display structure disposed within the community area, the display structure including at least one display area for use during a part-time community event;
a common parking area disposed between the permanent display structure and the permanent store structure; and
a thoroughfare disposed within the community area and sized for vehicular traffic, the thoroughfare connecting the access road to the common parking area.

23. The retail land development site of claim 22, in which the permanent display structure comprises a plurality of vendor bays.

24. The retail land development site of claim 23, in which at least one of the vendor bays is associated with the anchor retailer.

25. The land development site of claim 22, in which the common parking area includes a first portion located proximal the full-time retail area and a second portion located remote from the full-time retail area, and in which the community area is positioned adjacent the common parking area second portion.
